(19) United States
(12) Patent Application Publication
(10) Pub. No.: US 2010/0059434 A1
(43) Pub. Date: Mar. 11, 2010

(54) Abrasion Resistant Membrane Structure and Method of Forming the Same

(75) Inventors: Bruce Bishop, Arlington, MA (US); Jeremy Cardin, Marlborough, MA (US); Christopher B. Hoffman, Marlborough, MA (US); Richard Higgins, Reading, MA (US)

Correspondence Address: COATS & BENNETT, PLLC, 1400 Crescent Green, Suite 300, Cary, NC, 27518, US

(73) Assignee: HPD, LLC, Plainfield, IL (US)

(21) Appl. No.: 12/554,192

(22) Filed: Sep. 4, 2009

Related U.S. Application Data
(60) Provisional application No. 61/094,614, filed on Sep. 5, 2008.

(51) Int. Cl. B01D 71/70; B32B 37/02; B32B 3/06; B32B 3/12

(52) U.S. Cl. 210/490; 156/276; 156/77

(57) ABSTRACT

A membrane filtering device includes a substrate, a support membrane supported by the substrate, and a separation membrane supported by the support membrane. The separation membrane includes material that is substantially embedded into pores of the underlying support membrane. Optionally, the support membrane includes particles that are also substantially embedded into pores of the substrate.

### CROSS REFERENCE TO PROVISIONAL APPLICATION

This application claims priority under 35 U.S.C. §119(e) from the following U.S. provisional application: Application Ser. No. 61/094,614 filed on Sep. 5, 2008. That application is incorporated in its entirety by reference herein.

### U.S. GOVERNMENT RIGHTS

This invention was made with Government support under contract no. DE-FG02-05ER84315 awarded by the Department of Energy and grant no. 2003-33610-13085 awarded by the Department of Agriculture. The Government has certain rights in this invention.

### BACKGROUND OF THE INVENTION

Due to the presence of particulate matter in feed streams, for example dirt and grit carry over from harvesting of a feed crop, microfiltration and ultrafiltration membranes are often exposed to abrasive conditions during operation. Membranes used in applications such as clarification of sugar juice, grain and biomass hydrolysates, and grain ethanol stillage, generally can experience erosion over time. Some feed streams are more abrasive than others.

Raw sugar beet juice can be very abrasive to even durable membrane surfaces such as a titania membrane supported on a stainless steel substrate. Typically, after only a few thousand hours of operation, the titania membrane is likely to show substantial wear as some of the membrane may be removed from the substrate. As operation time increases, more and more of the titania membrane is removed from the substrate.

Various types of membranes are known, and some of these may be able to withstand high temperatures and abrasive feeds for some period of time. Among these types of membranes are tubular stainless steel, multi-channel ceramic, spiral wound polymeric and tubular polymeric membranes. In tubular stainless steel membranes, titania membranes are coated on and embedded into a stainless steel substrate and hence the stainless steel tends to protect portions of the embedded titania membrane. However, with such an embedded design, the exposed surface coating of the titania membrane can still be removed by abrasion. Moreover, these titania membranes exhibit poor tolerance to sulfuric acid and are relatively expensive. Multi-channel alumina membranes are probably the leading inorganic membranes used in industrial applications. While these membranes may be considered durable, they are generally not abrasion resistant. Polymeric membranes, both spiral wound and tubular, have been used or tested in various commercial and industrial applications. Spiral wound polymeric membranes, for example, are used for clarification of corn starch hydrolysate. In these applications, however, spiral wound polymeric membranes have numerous drawbacks or limitations. Such limitations include the inability to effectively handle feeds having a high concentration factor resulting in suitability for use in relatively high temperature environments.

Relatively fine-pored separation membranes formed as part of traditional multilayer asymmetric structures may typically be formed via casting of a fine-pored, coherent coating of submicron particulate. The slips used to prepare these “topcoats”, typically have about 10% wt. solids in water. This approach is capable of making membranes with high and stable process fluxes and good clarification capabilities. Unfortunately, these kinds of membranes are susceptible to being stripped off the supporting structure and losing their process flux stability.

There is a need for membrane structures that provide effective and reliable filtering while exhibiting high abrasion resistance.

### SUMMARY OF THE INVENTION

The present invention relates to a membrane filtering device that includes a substrate, a support membrane disposed on the substrate, and a separation membrane disposed at least partially within the support membrane. In one embodiment, the separation membrane is embedded into the underlying support membrane. In another embodiment, the separation membrane is embedded into the underlying support membrane and the support membrane is in turn embedded into the underlying substrate.

Other objects and advantages of the present invention will become apparent and obvious from a study of the following description and the accompanying drawings which are merely illustrative of such invention.

### BRIEF DESCRIPTION OF THE DRAWINGS

FIG. 1 is a pictorial view of a ceramic monolith in a housing with a portion of the housing cut away.

FIG. 2 is a schematic illustration of a portion of a cross section of a membrane device showing a separation layer embedded into an underlying support layer.

FIG. 3 is a schematic illustration similar to that shown in FIG. 2, but wherein the support layer is embedded into the underlying substrate.

FIG. 4 is a photograph of vials containing standard topcoat slip (left) and dilute nanoparticulate slips (center and right)

FIG. 5 is a chart showing skim milk process flux as a function of time for various membrane types

FIG. 6 is a chart showing skim milk process flux vs. time for CSI membranes before and after sugar juice process testing

FIG. 7 is a chart showing skim milk process flux vs. time for CM3-0.2 membranes before and after sugar juice process testing

FIG. 8 is a chart showing skim milk process flux vs. time for EB3-1A membranes before and after sugar juice processing testing

FIG. 9 is an SEM image of the unabraded CSI membrane after process testing

FIG. 10 is an SEM photo of the abraded CSI membrane after process testing

FIG. 11 is an SEM photo of the unabraded CM3-0.2 membrane after process testing

FIG. 12 is an SEM photo of the abraded CM3-0.2 membrane after process testing

FIG. 13 is an SEM photo of the unabraded EB3-1A membrane after process testing

FIG. 14 is an SEM image of the abraded EB3-1A membrane after process testing

FIG. 15 displays SEM images depicting the difference between the “coated” sintered SIC support layer (left) and the “embedded” sintered SiC support layer (right). Scale bar=100 μm

FIG. 16 displays cross-sectional SEM images of the 50% carbon black nested membranes. Scale bar=200 μm (left), =50 μm (right)

FIG. 17 is a chart showing a comparison of hydrolysate process performance of the embedded SiC support layer with and without a 50% carbon black embedded separation layer.

FIG. 18 is a chart showing hydrolysate process performance (shown as permeability) on the standard 0.1 μm and nested SiC membranes after 20 hours of abrasion vs. unabraded control samples

FIG. 19 displays plan-view SEM images of the unabraded (left) and abraded (right) standard 0.1 μm membranes after 100 hours of abrasion. Scale bar=100 μm

FIG. 20 displays cross-sectional SEM images of the unabraded (left) and abraded (right) embedded SiC support layer after 100 hours of abrasion. Scale bar=200 μm (left), 100 μm (right)

### DESCRIPTION OF EXEMPLARY EMBODIMENTS

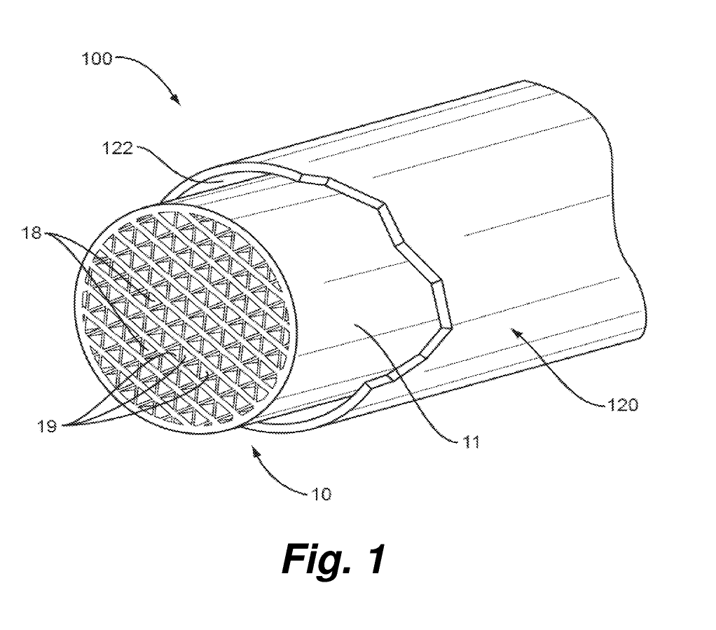

The present invention includes a monolith filter structure, generally indicated by the numeral 100 in FIG. 1. Such a filter structure 100 may be used to separate a feedstock stream into a permeate and a retentate. For example, the embedded membrane technology disclosed herein can be utilized in ceramic membrane devices such as described in U.S. Pat. Nos. 4,781,831; 5,009,781; and 5,108,601, the disclosures of which are expressly incorporated herein by reference.

Filter system 100 includes a porous monolith 10 encased in a housing 120. Feedstock to be filtered is caused to flow into an inlet or face end of monolith 10 via a plurality of feedstock passages or channels 18. Walls 19 surrounding each passage 18 are porous such that a permeate may be extracted from the feedstock and flow within the walls to the surface 11 of the monolith. The permeate is typically collected in a permeate receiving space or collection zone 122 formed between housing 120 and monolith 10. The remaining portion of the feedstock, the retentate, flows out of an outlet or retentate end of monolith 10 if the filter system 100 is operated with crossflow. The remaining portion of the feedstock can be flushed from either end of the filter system 100 if the filter system is operated in substantially a dead-end mode.

The present invention is a membrane or filtering structure that is incorporated into the ceramic filter system 100. This membrane structure forms the walls of the respective feedstock passageways 18. As will be appreciated from the following discussion, the membrane structure includes three distinct structures: 1) the porous monolith 10 which is sometimes referred to as the substrate, 2) a support layer or support membrane 14 that is generally disposed outwardly of the substrate, and 3) a separation layer or separation membrane 12 that is substantially embedded into the support membrane. Accordingly, it is appreciated that the filter system 100 is operative to produce a permeate from the feedstock that passes through the passageways 18. More particularly, the permeate passes through the separation membrane 12, through the support membrane 14 and through the substrate or monolith 10 to a collection zone.

The present invention is aimed at providing a filtering device having a design that tends to resist abrasion that occurs from the flow of some feedstocks through the feedstock passageways 18. To achieve this, the separation membrane 12 is substantially embedded into the support membrane or support layer 14. By substantially being embedded, it is meant that more than 50% of the particles or the mass of the separation membrane 12 is contained within the pores of the support membrane 14. In one embodiment the support membrane 14 is not substantially embedded into the substrate, but rather is secured to the substrate by a strong bond. In another embodiment it may be preferable to embed the support membrane 14 into the substrate. Again, in such a case, the support membrane would be substantially embedded into the substrate, again meaning that more than 50% of the particles or the mass of the support membrane would be embedded or held within pores formed in the adjacent substrate.

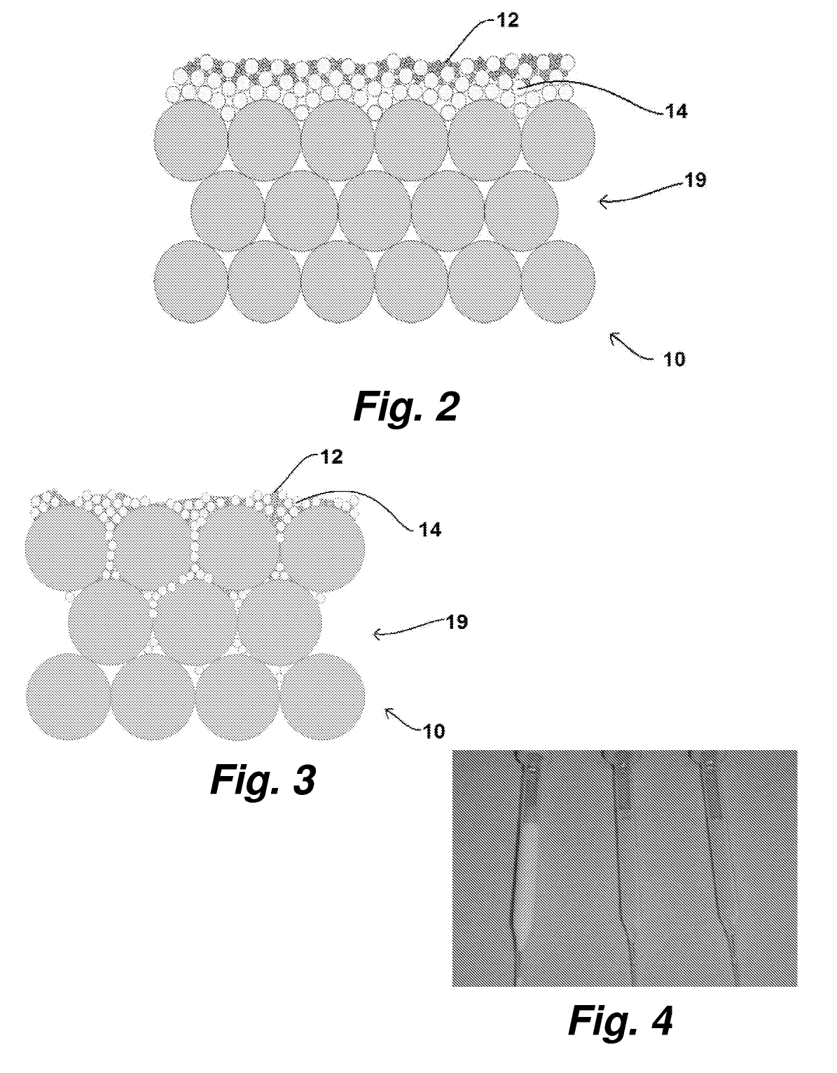

FIG. 2 illustrates one embodiment of the present invention. FIG. 2 is a schematic illustration of a portion of the membrane structure surrounding a passageway 18. As seen herein, the particles, or the particulate that forms the separation membrane 12 are substantially embedded into the membrane support 14 while the membrane support 14 is not substantially embedded into the substrate, but is strongly bonded thereto.

In one embodiment, illustrated in FIG. 3, not only is separation layer 12 embedded or incorporated into support layer 14 but the support layer is embedded into substrate. This arrangement is sometimes referred to as a nested embodiment. The nested embodiment can provide improved abrasion resistance for both separation layer 12 and support layer 14.

The membrane structures of the various embodiments of the present invention can allow for the use of high permeability, large pore size, and mechanically stable substrates such as honeycomb ceramic monoliths which are generally desirable for producing high surface area membrane elements. This is to be contrasted with utilization of fine-pored, low permeability monoliths, which typically require an excessive numbers of permeate conduits in a relatively large diameter membrane element which may make the structure expensive and impractical. Additionally, this is to be contrasted with relatively simple flat sheet, tubular, or small diameter multi-channel membrane configurations wherein the embedded membrane structures can be prepared by methods not applicable to high surface area monolithic membrane configurations.

Support layer 14 and separation layer 12 may be formed of the same material as the substrate or the substrate and the two layers may each be formed of different materials, and combinations thereof.

In one embodiment, all or a substantial part of substrate 10, support layer 14, and separation layer 12 is formed from silicon carbide, SiC. The interior surfaces of passageways 18 may have various materials applied thereto. Adhering substrate, support layer 14, and separation layer 12 together may be accomplished by using, for example, a pressureless sintering process. Separation layer 12 may be formed through a carbothermic reduction of a mixture of silica and carbon black applied to and embedded within support layer 14. In one embodiment support layer 14 may comprise a strong alumina-bonded zircon layer. Support layer 14 can comprise pressureless sintered SiC, using boron carbide and excess carbon as sintering aids. Separation layer 12 can be formed from a SiC preceramic polymer. Various preceramic polymers can be used such as the matrix polymers produced under the “Starfire” mark by Starfire Systems, Inc. of Malta, N.Y. To increase the permeability of the membrane, pore-formers may be used with the preceramic polymer. For example, carbon black can be mixed with a preceramic polymer and then removed oxidatively after thermally converting the preceramic polymer to a ceramic.

In some embodiments, substrate, support layer 14, and separation layer 12 may be of different materials. Among the materials that may be used for substrate 10 in such embodiments are SiC and mullite. Support layer 14 and separation layer 12 may be formed of various combinations of solid particles bound together and to substrate. Generally, bonding together of substrate 10, support layer 14, and separation layer 12 may involve coating and sintering processes.

To form layers 12, 14, dilute liquid compositions (or slips) including metal oxide particles in a range of about 0.25% vol. to about 25% vol. in the liquid can be used. A comparison of the slips used to prepare conventional topcoats and the embedded layers 12 or 14 of the present invention can be seen in FIG. 4 where three samples of aqueous slip are shown. The aqueous slip sample on the left in FIG. 4 is a standard topcoat formulation with about 10% wt. solids; the slip is opaque. The remaining two samples are of dilute nanoparticulate slips with about 1% wt. solids. The dilute slips are seen to be translucent, indicative of their low solids contents. Additionally the solids are present in small particle sizes, typically less than approximately 50 nm. The particles in these slips can penetrate porous layers onto which the particles are applied. The slips may be pH adjusted to enhance the dispersion of the inorganic particles. Generally after depositing the particles, a drying process removes any liquid prior to a sintering process to adhere to particles together and to substrate.

Volumetrically, the inorganic solids in the slips may be up to approximately 25% vol. The inorganic solids may include fine aluminum oxide (Al₂O₃) for producing hard and fine porous layers. The inorganic solids in the slips may also comprise zirconium orthosilicate, otherwise known as zircon (ZrSiO₄), especially for forming support layer 14. ZrSiO₄ may serve as a coarse refractory filler to slips utilized in forming support layer 14 on porous monolithic substrates, such as mullite, that have a substantial number of pores in such substrates are generally greater than approximately 10 microns in size. Also, ZrSiO₄ has good chemical durability and a lower coefficient of thermal expansion (CTE) than most chemically durable oxide materials. This allows the coating and bonding of layers to low thermal expansion substrates such as mullite.

A range of organic additives may also be utilized in the slips, including additives such as polymeric binders, dispersants, and anti-foams, all at relatively low concentrations typically less than 5% by weight of the total inorganic and organic solids in the slip. In addition, a metal oxide dopant, such as titanium dioxide, TiO₂, otherwise known as titania, may be used at less than approximately 1% wt. of the total solids in the slip to enhance sintering and hardness of support layer 14.

High proportions of fine Al₂O₃ may be utilized in support layer 14 when used with SiC and mullite monolithic substrates, and can result in greater hardness of the support layer. Fine Al₂O₃ may comprise approximately 20% wt. to approximately 40% wt. of the total solids in the first slip in such cases. Approximately forty percent by wt of solids appears to be about the highest concentration of Al₂O₃ that should be used in a first slip to coat a SiC or mullite substrate to form support layer 14 and avoid debonding of the layer or cracking after firing at temperatures in excess of 1,200° C.

Because coating with the first slip in forming support layer 14 can reasonably cover the large pores in a SiC substrate, the slip for a potential second coating in forming support layer 14 may have an even higher proportion of fine Al₂O₃ in the solids to increase the abrasion resistance at the top of support layer 14. In particular, the solids in the slip for the second coating may include Al₂O₃ up to approximately 65% by wt of total solids.

In one embodiment, embedded separation layer 12 can be formed using dilute slips of nanoparticulate Al₂O₃ precursors, such as boehmite nanoparticulate. The particles in these slips penetrate into support layer 14, embedding or incorporating separation layer 12 into the support layer. To form separation layer 12, an aluminum oxyhydroxide precursor to Al₂O₃, such as nanoparticulate boehmite in a dilute slip, can be brought into uniform contact with support layer 14. Casting of the nanoparticlulates results.

After casting the nanoparticulates using the slips, the structure of monolith 10 can be dried. To dry the structure, passages 18 can be sealed off and the structure introduced into a drying environment. The structure is thus only allowed to dry through the outside circumference of monolith 10. This drying process may be observed to draw the nanoparticulates into support layer 14 to form embedded separation layer 12.

As further illustration of the present invention, two examples of actual membrane structures are provided below.

### Example I

### Embedded Separation Layer

The embodiment illustrated in FIG. 2 is the basis for this example. Substrate is a SIC monolith 10. Support layer 14 was formed utilizing two successive slips, each including an aqueous mixture of inorganic materials. Both slips included 25% vol. inorganic solids. The inorganic solids utilized in the slips were Al₂O₃ and ZrSiO₄. Al₂O₃ was provided at 40% wt. of the solids in the first slip, and ZrSiO₄ was included at 60% wt. Organic additives were also provided in the first slip. Examples of organic additives that can be used are polyvinyl alcohol and a polysiloxane antifoam. In one embodiment the organic additives made up approximately 0.4% wt. of the total solids in the slip. The slips were pH adjusted to pH 3 by nitric acid. The solids in the second slip, for the second coating, included approximately 65% wt. Al₂O₃, approximately 35% wt. ZrSiO₄, and approximately 0.4% wt. titania. The process used to deposit support layer 14 was to uniformly contact substrate with the slip. Separation layer 12 was formed by similarly applying a slip coat where the Al₂O₃ was provided indirectly via a boehmite nanoparticulate suspension to provide 1% wt. boehmite in the solids of the slip. Boehmite is a precursor of Al₂O₃.

After casting the nanoparticulates from the slip, the monolith was dried by bringing the drying front to the skin of the monolith. This was done by sealing off the passageways 18 and only allowing drying through the outside circumference of the monolith. This drying process draws the nanoparticulates into support layer 14 thereby forming the embedded separation layer 12 within which the beohmite nanoparticles were converted to Al₂O₃ by firing at a temperature of approximately 1,200° C.

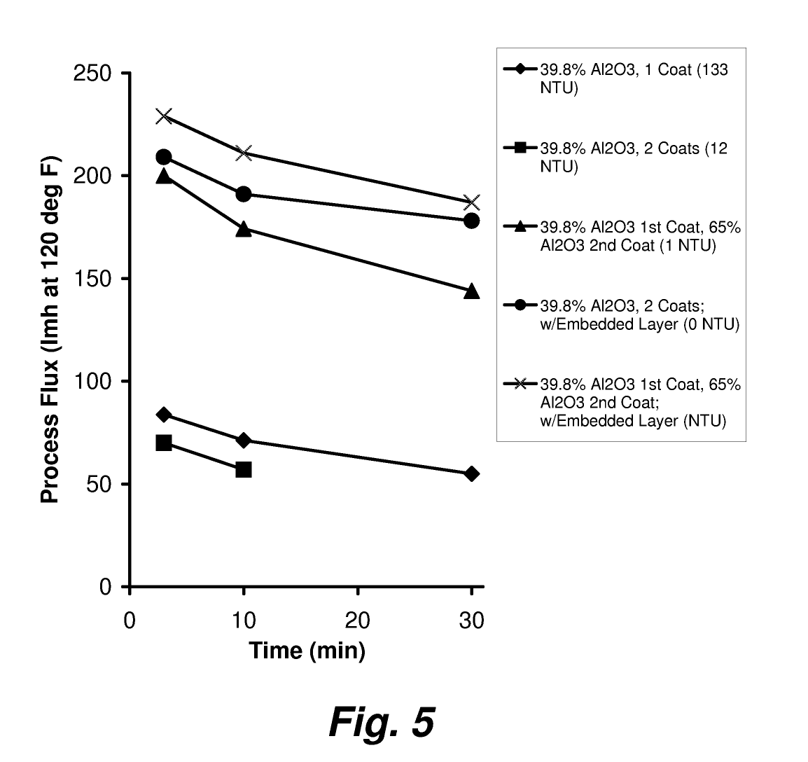

Pairs of lab-scale coupons of a series of membrane types were prepared as listed in Table I. The samples included a standard 0.2 micron MF membrane (CM3-0.2), a CSI MF membrane type, and an embedded membrane type (EB3-1A), the latter prepared as described above. The CM3-0.2 and the CSI membranes are conventional membranes inasmuch as the membrane layers are not embedded. The coupons were tested on dilute skim milk at about 10 ft/s crossflow velocity and about 30 psi transmembrane pressure. The embedded separation layer 12, represented in EB3-1A, exhibited increased process flux, process flux stability, and permeate quality of the membranes as shown in FIG. 5.

TABLE I
Selected Membrane Types for Evaluation

| | | | 2^{nd} Membrane | Water Flux |
|---|---|---|---|---|
| Membrane | Substrate | | (Separation | (lmh-bar @ |
| Type | Material | 1^{st} Membrane | Layer) | 25° C.) |
| CM3-0.2 | SiC | 39.8% Al₂O₃, | Fine participate | 375-500 |
| | | 2 coats | Al₂O₃ topcoat | |
| EB3-1A | SiC | 1^{st} Coat | Embedded with | 270-410 |
| | | 39.8% Al₂O₃, | Al₂O₃ | |
| | | 2^{nd} Coat | Nanoparticulate | |
| | | 65% Al₂O₃ | | |
| CSI | Cordierite | 20% Al₂O₃, | Very fine | 320-460 |
| | | 2 coats | particulate Al₂O₃ | |
| | | | topcoat | |

After testing on dilute skim milk, half of these samples were abraded at 15 ft/s crossflow velocity for 95 hours using a 5% wt. aqueous suspension of 20-μm particle size corundum. Abrasion was conducted with permeate flow turned off so as to minimize deposition of corundum and membrane debris on and/or in the membrane surfaces. The pairs of membranes were then tested for process performance on raw sugar beet juice. While the process performance of the membranes were generally very good (175 lmh process flux and non-turbid permeate), there were no differences between abraded and non-abraded samples.

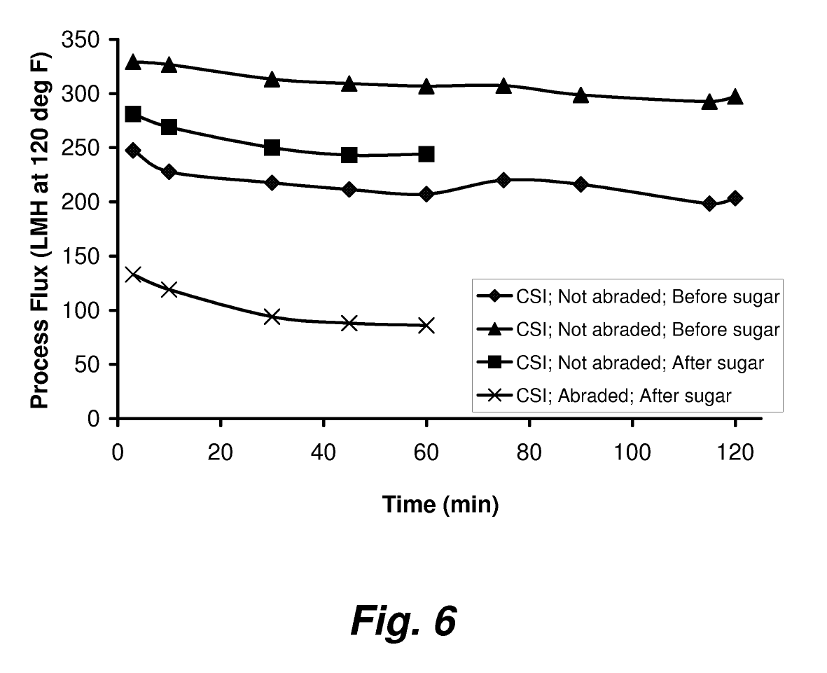

Process testing with dilute skim milk was conducted again. The micelles in skim milk were anticipated to be smaller in size than the colloids and particulates in sugar juice. Hence, it was thought that membrane erosion was more likely to be shown by crossflow microfiltration of skim milk. After cleaning the membranes using a two-stage process of first soaking in citric acid (pH 2; 90° C.) and then recirculating a pH 10 solution of sodium hypochlorite and detergent through the membranes at about 60° C., the samples were tested on 10% skim milk at about 8 ft/s crossflow velocity and 30 psi transmembrane pressure. The results are shown in FIGS. 6 through 8.

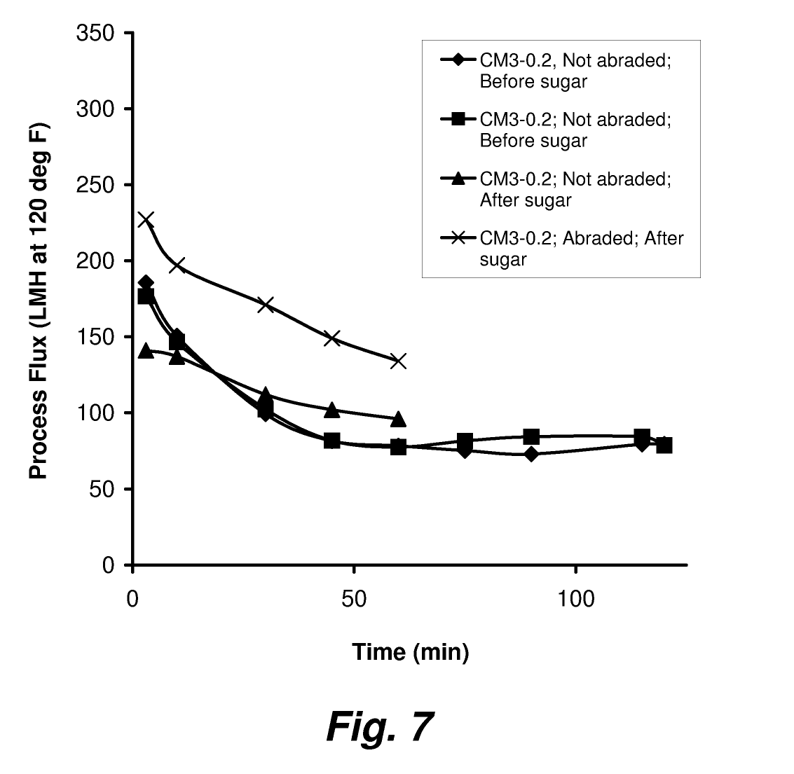

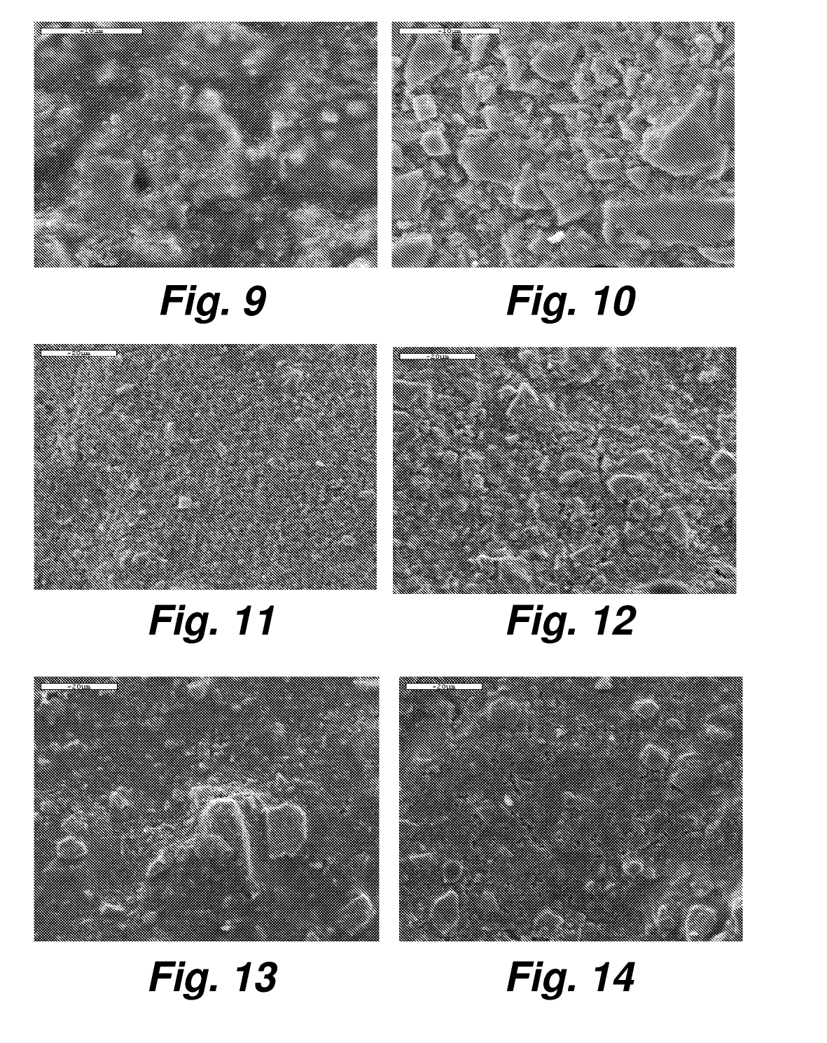

FIGS. 6 and 7 show the results of the traditional multilayer MF membranes (non-embedded). The abraded CSI membrane was damaged by exposure to the abrasive slurry based on (a) the much reduced skim milk process flux for this part after abrasion and (b) the unabraded membrane having the same process flux as before sugar juice process testing. In addition, the turbidity passage of the abraded part increased from about 1 NTU to over 160 NTU. These process data are in agreement with the SEM photomicrographs that show that the separation layer of the CSI membrane was stripped off by the effects of the abrasive-laden slurry. This can be seen by comparing the photomicrographs in FIG. 9 (unabraded) to that in FIG. 10 (abraded). The unabraded membranes are fairly rough and with some defects but there is a separation membrane layer that is no longer present in the abraded sample.

For the 0.2-μm MF membrane (CM3-0.2), exposure to the corundum slurry did not significantly change the skim milk process flux of the abraded sample, and the unabraded sample process flux also remained unchanged. The turbidity passage for both membranes was unchanged. However, the SEM photomicrographs reveal that the top separation layer was damaged. FIG. 11 shows the unabraded membrane and FIG. 12 shows the abraded membrane sample. The unabraded sample is not as rough as the CSI membrane, a result of the SiC substrate, and separation layer 12 is clearly shown at high magnification. After abrasion, the membrane surface is much rougher indicating that some of separation layer 12 was removed.

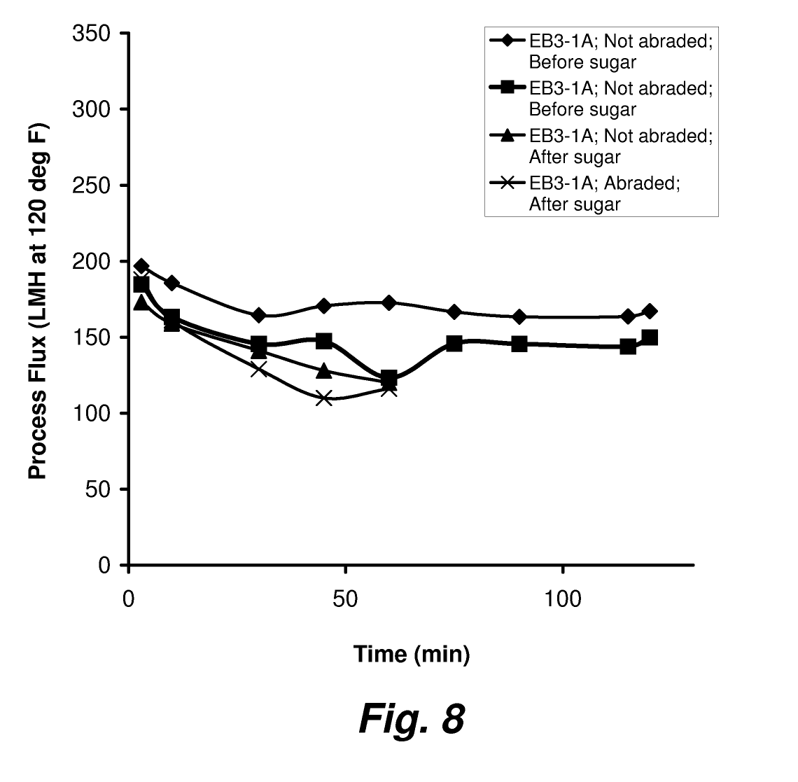

Both abraded and unabraded EB3-1A membranes performed essentially the same after sugar juice process testing and gave very similar skim milk process fluxes to those prior to sugar juice testing (FIG. 8). The difference in skim milk process flux of about 30 LMH after 60 minutes of testing is typical for skim milk process test results as can be seen with the other membrane types. The turbidity passage was not significantly changed for either membrane from the initial results. The microstructural analysis was in agreement with the skim milk process test results. The unabraded membrane (shown in FIG. 13) is not significantly different from the abraded membrane (FIG. 14). There appears to be a fine material nestled within support layer 14 pores that may be the embedded material. There are some hole defects in the abraded membrane but some can be seen in the unabraded membrane as well.

The information obtained from the dilute skim milk process tests and SEM analyses demonstrate the feasibility of the abrasion-resistant embedded membrane approach. The embedded membrane prepared on SiC monolithic substrate comprising a support layer 14 made up a first coat (having Al₂O₃ 40% wt. of total solids) and a second coat (having Al₂O₃ 65% wt. of total solids) and Al₂O₃ nanoparticulate separation layer 12 (EB3-1A) had no significant changes in skim milk process flux or microstructure after abrasion with corundum slurry and sugar juice testing. The two conventional (non-embedded) two-layer membranes were damaged by the abrasion test.

### Example II

### Support Layer Embedded in Substrate and Separation Layer Embedded in Support Layer

This example is based on the embodiment illustrated in FIG. 3. A nested, abrasion-resistant membrane structure was fabricated from SiC materials and then evaluated for its abrasion resistance performance. The first step in this example was to fabricate a porous SiC monolithic substrate to be used as the mechanical support for the membrane. These substrates are formed by extrusion followed by drying and firing of the parts to temperatures in excess of 2,100° C. in an inert atmosphere to render them strong and porous. For making the nested structure, a relatively large pored, nominal 15 micron pore size monolith was used.

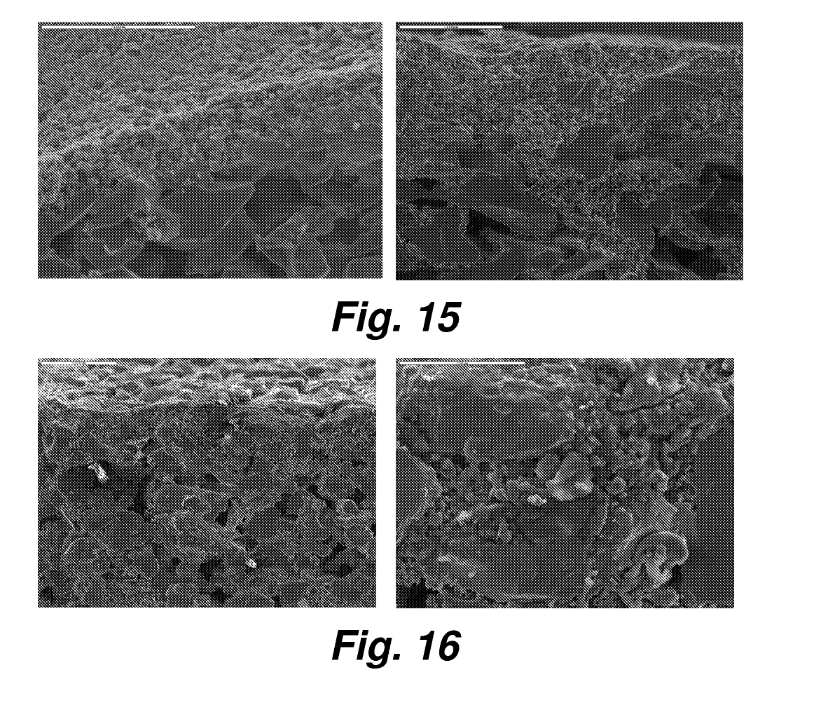

The next step in fabricating this type of membrane was to deposit by slip casting an embedded support layer within the pores of the mechanical support. An aqueous slip containing 23 vol % inorganic solids was prepared using coarse (more than 1 micron) and fine (less than 1 micron) SiC particulate along with boron carbide and carbon black sintering aides (each less than 1 vol % in the slip). This coating was slip cast on the SiC substrate and then fired to nominally 2,100° C. in an inert atmosphere. FIG. 15 compares the structures of a non-embedded SiC support layer and an embedded SiC support layer.

The separation layer which was to be embedded in the embedded support layer (i.e., the nested structure) was fabricated using a preceramic polymer and a pore former. A non-aqueous mixture containing 40 g/L of preceramic polymer (Starfire Systems), which converts to SIC upon heat treating and 50% carbon black, based on polymer volume was prepared and contacted with samples coated with the embedded support layer. After drying the coating, the samples were fired in an inert atmosphere to nominally 1,100° C. The sample was oxidized in air at about 525° C. to burn out the pore former and render the SiC membrane hydrophilic. The pore former in this case was found to be beneficial in increasing the water flux of the membrane to more than 1000 lmh-bar at ambient conditions. In addition, membranes formed using this methodology were very hard and not scratched by hardened tool steel. A photomicrograph of a sample is shown in FIG. 16.

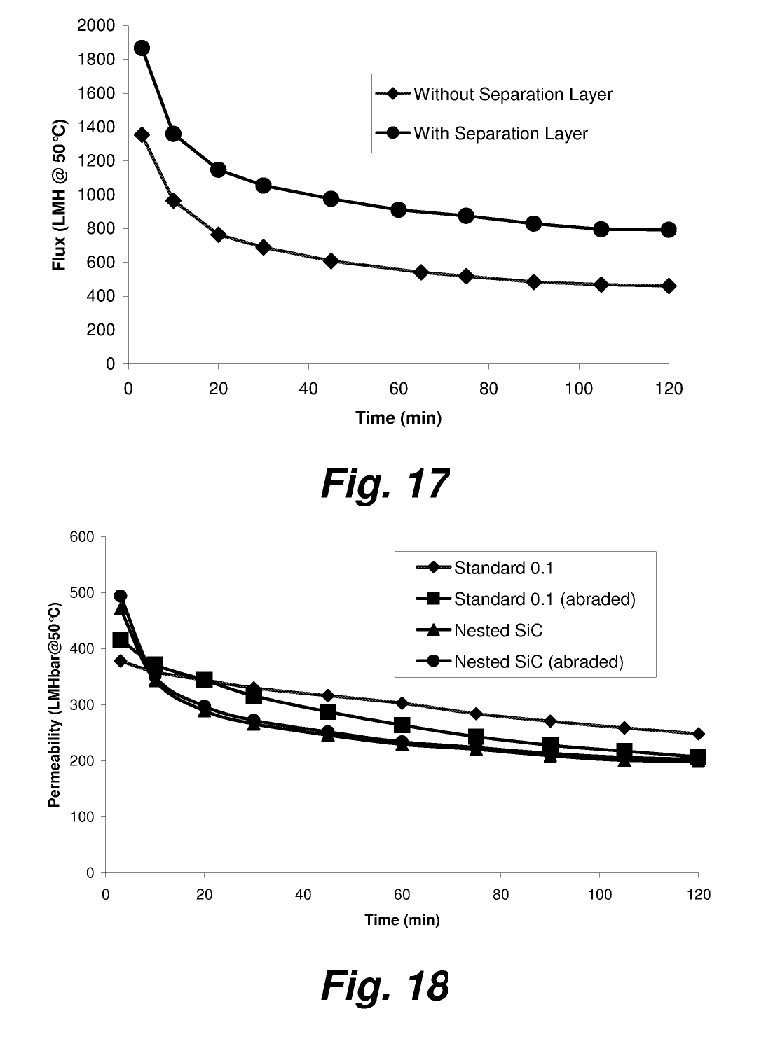

While the embedded separation layer is not readily visible in the micrograph, its effect on process performance is apparent. Using a feed of hemicellulose hydrolysate liquor removed from dilute acid pretreated corn stover supplied by the US Department of Energy's National Renewable Energy Laboratory, the membrane performance of samples with and without the embedded separation layer was evaluated. As seen in FIG. 17, including the separation layer significantly increased process flux.

Accelerated abrasion tests were carried out on a nested SiC developmental MF membrane as well as a conventional 0.1-μm MF membrane. After 20 hours of continuous abrasion with a 5 wt % slurry of 20-μm alumina abrasive, samples were removed from the system and characterized for hydrolysate process performance. The hydrolysate permeability curves for control and abraded samples of the 0.1 μm membrane and the nested SIC developmental membrane are shown in FIG. 18. The data are presented as permeabilities (Imh-bar) rather than process flux to remove any effect that positioning in the test loop had on performance (due to the pressure drop in the loop, upstream parts have a higher transmembrane pressure when there is no backpressure on the permeate). The performance of the abraded 0.1 μm standard membrane showed a decline in performance, while the nested membrane flux remains equivalent for the abraded and control parts. This is an indication that the nested (embedded) membranes have superior abrasion resistance than conventional membrane technology. The decrease in permeability in the abraded standard 0.1 μm membrane is attributed to increased fouling of the membrane. As a traditional membrane is eroded, the larger pores of the support layer are exposed. These larger pores will foul more readily than the fine pores of the separation layer. Therefore, it is expected that an abraded membrane will have decreased permeability, which is what was observed for the abraded standard 0.1 μm membrane. These four samples were tested simultaneously; therefore, the differences observed are not a result of variations in hydrolysate liquor feed.

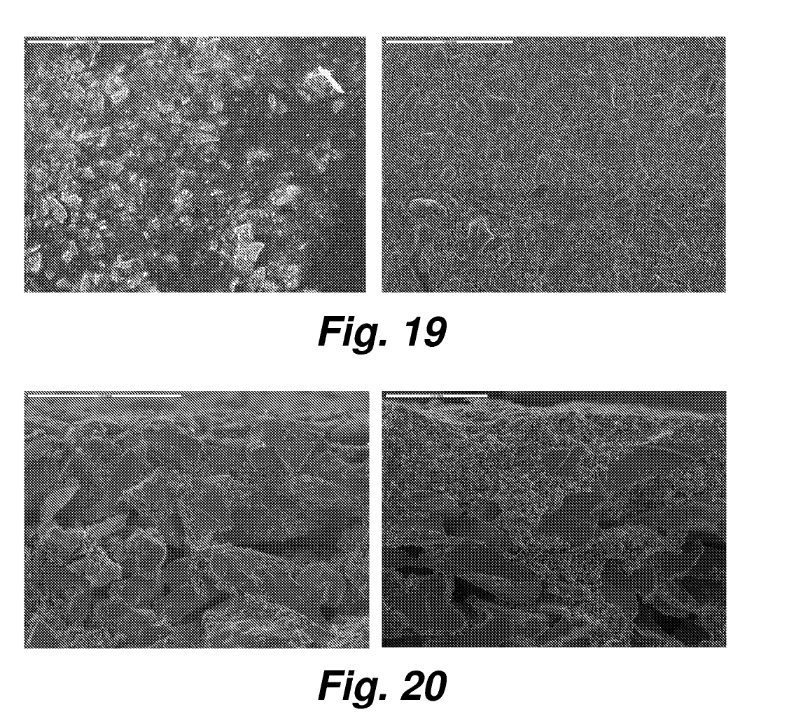

Despite not being able to run more hydrolysate tests due to a lack of feed, the membranes were abraded with the alumina slurry for an additional 60 hours. After 100 hours total time, the membranes were broken open and visually inspected. SEM images comparing the abraded membrane samples with unabraded samples are shown in FIGS. 19 and 20. In FIG. 19, it is apparent that the fine (0.1 μm) separation layer has been removed from the membrane surface. In FIG. 20, the support layer can be observed in both the unabraded control and abraded sample images. The embedded separation layer is not visible with the resolution of the SEM images obtained; however, because the technical approach was to embed the separation layer within the support layer, it is suggested that the separation layer would remain after abrasion so long as the support layer has not been severely eroded.

The present invention may, of course, be carried out in other specific ways than those herein set forth without departing from the scope and the essential characteristics of the invention. The present embodiments are therefore to be construed in all aspects as illustrative and not restrictive and all changes coming within the meaning and equivalency range of the appended claims are intended to be embraced therein.

1. A filtration device for receiving a feedstock at a feed end and for separating the feedstock into a permeate, the filtration device comprising:
a. a monolith formed of porous material;
b. a plurality of feedstock passageways extending through the monolith from the feed end to an opposite end;
c. respective feedstock passageways including a surrounding membrane structure comprising:
i. a support membrane including inorganic particles bonded to the porous monolith; and
ii. a separation membrane comprising material substantially embedded into the support membrane such that permeate flows through the separation membrane and the support membrane.

2. The filtration device of claim 1, wherein the support membrane and the separation membrane include particles of a metal oxide, and wherein the support membrane comprises a structure formed by metal oxide particles and pores dispersed about the metal oxide particles, and wherein the separation membrane includes metal oxide particles that are smaller than the pores of the support membrane and which are substantially embedded in the pores of the support membrane.

3. The filtration device of claim 2, wherein the metal oxide particles that form a part of the support membrane and the separation membrane include aluminum oxide particles.

4. The filtration device of claim 1 wherein the support membrane includes two or more coatings of inorganic particles.

5. The filtration device of claim 4, wherein the two or more coatings include particles of aluminum oxide.

6. The filtration device of claim 1, wherein the support membrane includes particles of aluminum oxide.

7. The filtration device of claim 6 wherein the support membrane comprises a mixture of zircon and aluminum oxide particles.

8. The filtration device of claim 1 wherein in the porous material of the monolith, the support membrane and the separation membrane include silicon carbide.

9. A method of forming a filtration device, comprising:
a. forming a monolith of porous material;
b. forming a plurality of feedstock passageways in the monolith wherein respective passageways include a membrane structure comprising a substrate including a portion of the porous material of the monolith, a support membrane bonded to the substrate and a separation membrane substantially embedded in the membrane support;
c. wherein bonding the support membrane to the porous substrate includes coating the porous substrate with a composition including inorganic particles;
d. after coating the porous substrate with the composition including inorganic particles, bonding the support membrane to the monolith;
e. after bonding the support membrane to the porous substrate, substantially embedding the separation membrane into the support membrane; and
f. bonding the separation membrane to the support membrane.

10. The method of claim 9 including forming the support membrane by coating the substrate with an aqueous composition containing approximately 20 to approximately 65 wt. % of inorganic solids.

11. The method of claim 9 including forming the support membrane by coating the substrate with an aqueous composition containing approximately 20 to approximately 65 wt. % of aluminum oxide particulate and thereafter heating the monolith to a temperature of at least 1000° C.

12. The method of claim 9 including forming the embedded separation membrane by coating the support membrane with a pre-ceramic polymer, and after coating the membrane support with the pre-ceramic polymer heating the monolith to a temperature of at least 500° C. to convert the pre-ceramic polymer to particulate which is substantially embedded in the support membrane.

13. The method of claim 9 including forming the embedded separation membrane by coating the support membrane with a non-aqueous mixture of a pre-ceramic polymer and a pore former, drying the coating of the pre-ceramic polymer and pore former, heating the monolith after the coating of the pre-ceramic polymer and pore former has been applied to the support membrane, and burning out a substantial portion of the pore former.

14. The method of claim 9 wherein the substrate, membrane support, and separation membrane include SiC.

15. The method of claim 12 including:
a. coating the substrate with a composition containing approximately 5 to approximately 50 vol. % of SiC particulate;
b. heating the coating of SiC particulate to a temperature of at least 1700° C. in a substantially inert atmosphere to form the support membrane;
c. after applying the support membrane, coating the support membrane with a mixture containing approximately 20 to approximately 80 g/L of a pre-ceramic polymer and a pore former where the pre-ceramic polymer is convertible to SIC by heating;
d. drying the pre-ceramic polymer and pore former;
e. heating the monolith to a temperature of at least 850° C.; and
f. burning out a substantial portion of the pore former to form pores in the membrane support.

16. The method of claim 9, further including substantially embedding the support membrane into the substrate such that the separation membrane is substantially embedded into the support membrane and the support membrane is substantially embedded into the substrate.

17. The filtration device of claim 1, wherein the support membrane including inorganic particles is substantially embedded into the porous monolith such that the separation membrane is substantially embedded into the support membrane and the support membrane is in turn substantially embedded into porous monolith.

18. A filtration device for receiving a feed stock at a feed end and for separating the feed stock into a permeate, the filtration device comprising:
a. a monolith formed of porous material;
b. a plurality of feed stock passageways extending through the monolith from the feed end to an opposite end;
c. respective feed stock passageways including a surrounding membrane structure comprising:
i. a substrate formed in part at least by the porous material of the monolith, the substrate including pores formed therein;
ii. a support membrane including inorganic particles where the particles of the support membrane are substantially embedded in the pores of the substrate and wherein the particles of the support membrane are bonded to the substrate; and
iii. a separation membrane including material substantially embedded into pores formed in the support membrane such that permeate flows through the separation membrane and the support membrane as well as the substrate.

19. The filtration device of claim 18, wherein the support membrane and the separation membrane include particles of metal oxide, and wherein the support membrane comprises a structure formed by metal oxide particles and the pores dispersed about the metal oxide particles, and wherein the separation membrane includes metal oxide particles that are smaller than the pores of the support membrane and which are substantially embedded in the pores of the support membrane.

20. The filtration device of claim 19, wherein the metal oxide particles that form a part of the support membrane and the separation membrane include aluminum oxide particles.

21. The filtration device of claim 18, wherein the substrate comprises a porous ceramic material.

22. A method of forming a filtration device, comprising:
a. forming a monolith of porous material;
b. forming a plurality of feed stock passageways in the monolith wherein respective passageways include a membrane structure comprising
i. a substrate that includes a portion of a porous material of a monolith; and
ii. a support membrane including inorganic particles supported by the substrate and a separation membrane including inorganic particles supported on the membrane support;
c. the method including substantially embedding the particles of the support membrane into the substrate and bonding the particles of the membrane support to the substrate; and
d. embedding the material of the separation membrane into pores formed in the membrane support and bonding the separation membrane to the membrane support.

23. The method of claim 22, including forming the membrane support by coating the substrate with an aqueous composition containing approximately 20 to approximately 65 wt. % of inorganic particles.

24. The method of claim 22, including forming the support membrane by coating the substrate with an aqueous composition containing approximately 20 to approximately 65 wt. % of aluminum oxide particles and thereafter heating the monolith to a temperature of at least 100° C.

25. The method of claim 22, including forming the embedded separation membrane by coating the support membrane with a pre-ceramic polymer, and after coating the membrane support with the pre-ceramic polymer, heating the membrane support to a temperature of at least 500° C. to convert the pre-ceramic polymer to a particulate which is substantially embedded in the support membrane.

26. The method of claim 22, including forming the embedded separation membrane by coating the support membrane with a non-aqueous mixture of a pre-ceramic polymer and a pore former, drying the coating of the pre-ceramic polymer and pore former, heating the monolith after the coating of the pre-ceramic polymer and pore former has been applied to the support membrane, and burning out a substantial portion of the pore former.

27. The method of claim 22, wherein the substrate, membrane support and separation membrane include SiC.

28. The method of claim 22 including:
a. coating the substrate with an aqueous composition containing approximately 5 to approximately 50 wt. % of SiC particulate;
b. heating the coating of SIC particulate to a temperature of at least 1700° C. in a substantially inert atmosphere to form the support membrane;
c. after applying the support membrane, coating the support membrane with a mixture containing approximately 20 to approximately 80 g/L of a pre-ceramic polymer and a pore former where the pre-ceramic polymer is convertible to SiC by heating;
d. drying the pre-ceramic polymer and pore former;
e. heating the monolith to a temperature of at least 850° C.; and
f. burning out a substantial portion of the pore former to form pores in the membrane support.
